(19) United States
(12) Patent Application Publication
(10) Pub. No.: US 2006/0086589 A1
(43) Pub. Date: Apr. 27, 2006

(54) Device for adjusting storage space of a magazine

(75) Inventor: Jack Chen, Taichung (TW)

Correspondence Address: CHARLES E. BAXLEY, ESQ., 90 JOHN STREET, THIRD FLOOR, NEW YORK, NY, 10038, US

(73) Assignee: Basso Industry Corp.

(21) Appl. No.: 10/970,081

(22) Filed: Oct. 21, 2004

(51) Int. Cl. B65G 37/00; B65G 1/00

(52) U.S. Cl. 198/347.1

(57) ABSTRACT

The present invention relates to a device capable of automatically adjusting storage space of a magazine, wherein a Π-shaped adjusting plate is disposed in the magazine and provided with an abutting side in response to the push member assembly. When the push member assembly is pulled downward to load the staples, the adjusting plate will be moved backward by the guiding bolt to push against the elastic member, so that the storage space of the magazine is changed automatically. Thus, the magazine can be used to hold different sized staples. Furthermore, when the staples are positioned by the push member assembly, the abutting side of the adjusting plate will be pushed by the elastic members to push tightly against the staples.

### BACKGROUND OF THE INVENTION

1. Field of the Invention

The present invention relates to a stapler, and more particularly to a device which is capable of adjusting the storage space of a magazine automatically, so that the magazine can be used to hold different sized staples.

2. Description of the Prior Arts

Since a conventional magazine only can hold single-sized staples, a stapler has to use different magazines when different sized staples need be used during construction. It is not only inconvenient but also uneconomical for the worker to take several different magazines with him during construction. Thereby, how to produce a device which can enable a magazine to hold different sized staples is one of the most critical problems that the producers need to solve, and also this is the motivation of the present invention.

The present invention has arisen to mitigate and/or obviate the afore-described disadvantages of the conventional magazine for a stapler.

### SUMMARY OF THE INVENTION

The primary objective of the present invention is to provide a device capable of automatically adjusting storage space of a magazine, wherein a Π-shaped adjusting plate is disposed in the magazine and provided with an abutting side in response to the push member assembly. When the push member assembly is pulled downward to load the staples, the adjusting plate will be moved backward by the guiding bolt to push against the elastic member, so that the storage space of the magazine is changed automatically. Thus, the magazine can be used to hold different sized staples. Furthermore, when the staples are positioned by the push member assembly, the abutting side of the adjusting plate will be pushed by the elastic members to push tightly against the staples.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is an exploded view of a device for adjusting storage space of a magazine in accordance with the present invention;

FIG. 2 is an assembly cross sectional view of the device for adjusting storage space of a magazine in accordance with the present invention;

FIG. 3 is an assembly cross sectional view of showing the device for adjusting storage space of a magazine in accordance with the present invention before the magazine is loaded;

FIG. 4 is an assembly cross sectional view of showing the device for adjusting storage space of a magazine in accordance with the present invention after the magazine is loaded.

### DETAILED DESCRIPTION OF THE PREFERRED EMBODIMENTS

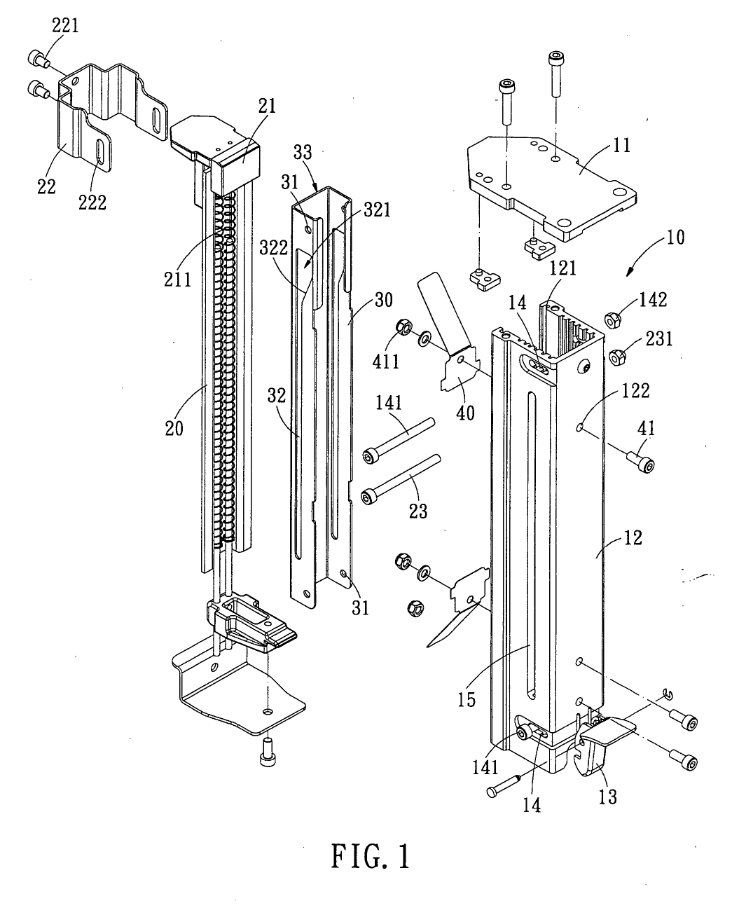

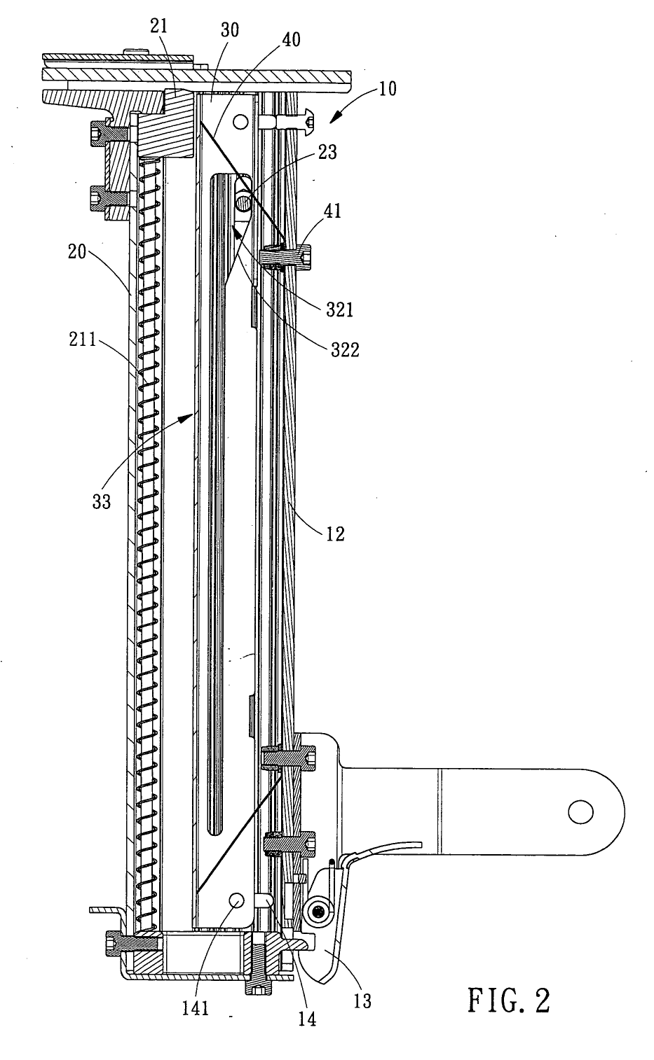

Referring to FIGS. 1 and 2, a device for adjusting storage space of a magazine in accordance with the present invention comprises: a magazine 10, a push member assembly 20, a Π-shaped adjusting plate 30 and two elastic members 40.

The magazine 10 includes an upper plate 11, a housing 12 and a lower fastener 13. On the housing 12 and adjacent to the upper plate 11 and the lower fastener 13 are provided two pairs of upper and lower lateral holes 14, in each pair of which is inserted a limiting bolt 141 screwed with a nut 142. Between the upper and the lower lateral holes 14 is formed a vertical elongated hole 15, on two opposite internal sidewalls of the housing 12 are provided a plurality of tracks 121, and on another internal sidewall of the housing 12 are formed a plurality of positioning holes 122.

The push member assembly 20 is slideably disposed in the tracks 121 of the magazine 10 and is able to move up and down therein. The lower fastener 13 serves to fix the push member assembly 20. A push block 21 and two restoring springs 211 are disposed in the push member assembly 20, and a guide plate 22 is fixed at the front end of the push member assembly 20 by a screw 221. The guide plate 22 is formed with a pair of through holes 222 through which a guiding bolt 23 is inserted, so as to confine the guide plate 22 in the vertical elongated holes 15 of the magazine 10 by using a screw nut 231.

The Π-shaped adjusting plate 30 is confined between the inner wall of the magazine 10 and the push member assembly 20, at the upper and the lower ends of the Π-shaped adjusting plate 30 are formed through holes 31 for insertion of the limiting bolt 141, so that the Π-shaped adjusting plate 30 is limited by the limiting bolt 141 and is allowed to move laterally only. At both opposite sides of the Π-shaped adjusting plate 30 is vertically provided a slot 32 in which is formed a receiving hole 321 in response to the guide plate 22 and the guiding bolt 23, the width of the slot 32 is equal to that of the lateral holes 14. The receiving hole 321 and the slot 32 are connected by a bevel surface 322, the guiding bolt 23 at the front end of the push member assembly 20 is inserted in the slot 32, and the Π-shaped adjusting plate 30 is provided an abutting side 33 in response to the push member assembly 20.

The elastic members 40 is fixed at the positioning holes 122 on the housing 12 of the magazine 10 by a bolt 41 and a screw nut 411 in such a manner that the elastic members 40 is biased between the Π-shaped adjusting plate 30 and the housing 12.

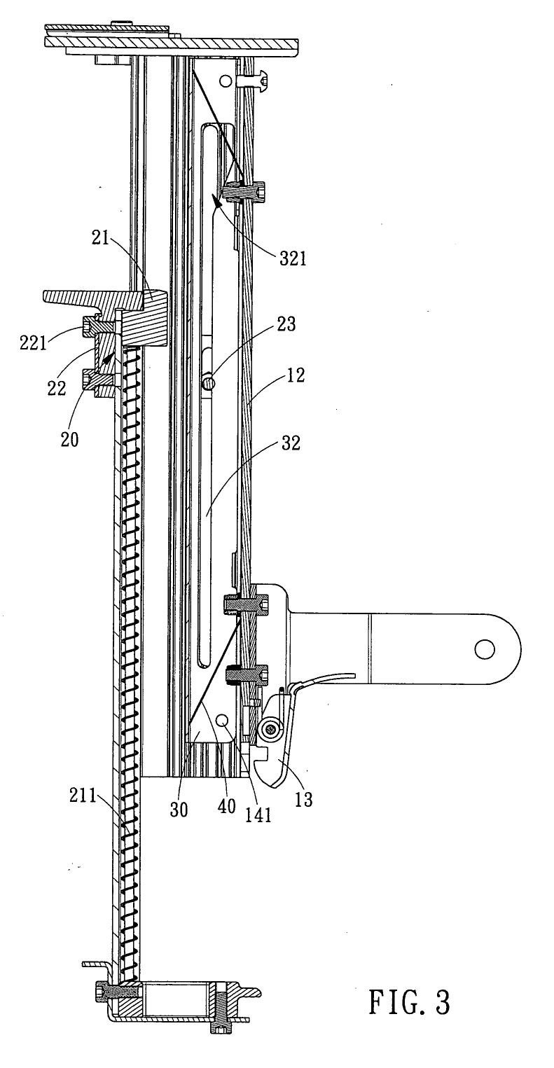

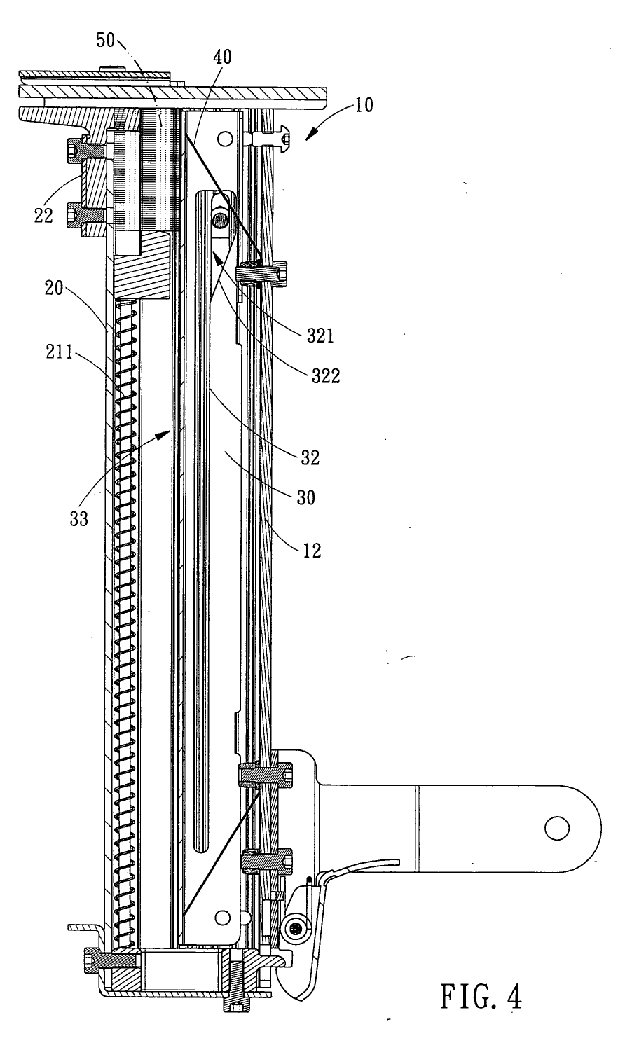

Referring further to FIGS. 3 and 4, when the staples 50 are positioned by the push block 21 of the push member assembly 20, the housing 12 and the staples 50 will move upward along with the guide plate 22, and the guiding bolt 23 of the guide plate 22 also will move up to the top edge of the vertical elongated hole 15 of the housing 12. Meanwhile, the guiding bolt 23 in the slot 32 enters the receiving hole 321, thus, the Π-shaped adjusting plate 30 will be pushed by the elastic members 40 to push tightly against the staples 50 in such a manner that the abutting side 33 of the Π-shaped adjusting plate 30 abuts tightly against the staples 50. Thereby, the staple 50 in the magazine 10 can be positioned by the Π-shaped adjusting plate 30 automatically and firmly.

On the other hand, when pulling the push member assembly 20 downward to load the staples 50, the guiding bolt 23 at the front end of the push member assembly 20 will slide downward synchronously. Meanwhile, during the movement of the guiding bolt 23 from the receiving hole 321 to the slot 32 via the bevel surface 322, the abutting surface 33 of the Π-shaped adjusting plate 30 will be moved backward by the guiding bolt 23. The limiting bolt 141 in the lateral holes 14 keeps the vertical position of the Π-shaped adjusting plate 30 relative to the housing 12 unchanged, so that the Π-shaped adjusting plate 30 will move backward to compress the elastic member 40 when the push member assembly 20 is being pulled downward, and the abutting side 33 of the Π-shaped adjusting plate 30 also moves backward to change the storage space of the housing 12. Through this way, the magazine 10 can be used to hold different sized staples 50 automatically.

While we have shown and described various embodiments in accordance with the present invention, it should be clear to those skilled in the art that further embodiments may be made without departing from the scope of the present invention.

What is claimed is:

1. A device for adjusting storage space of a magazine comprising:
a magazine including an upper plate, a housing and a lower fastener, on the housing and adjacent to the upper plate and the lower fastener provided two pairs of upper and lower lateral holes, in each pair of the lateral holes being inserted a limiting bolt screwed with a nut, between the upper and the lower lateral holes formed a vertical elongated hole, on two opposite internal sides of the housing of the magazine provided a plurality of tracks;
a push member assembly slideably disposed in the tracks of the housing of the magazine and being able to move up and down therein, a push block disposed in the push member assembly, and a guide plate fixed at a front end of the push member assembly, the guide plate formed with a pair of through holes through which a guiding bolt being inserted, so as to position the guide plate in the vertical elongated holes of the magazine;
a Π-shaped adjusting plate confined between inner wall of the magazine and the push member assembly, at an upper and a lower ends of the Π-shaped adjusting plate formed through holes for insertion of the limiting bolt of the housing, wherein the Π-shaped adjusting plate is limited by the limiting bolt and only able to move horizontally, at both opposite sides of the Π-shaped adjusting plate vertically provided a slot in which is formed a receiving hole in response to the guide plate and the guiding bolt, a width of the slot is equal to that of the lateral holes, the receiving hole and the slot are connected by a bevel surface, the guiding bolt of the push member assembly is inserted in the slot, and the Π-shaped adjusting plate is provided an abutting side in response to the push member assembly;
a plurality of elastic members fixed on the housing of the magazine and biased between an internal sidewall of the Π-shaped adjusting plate and the internal sidewall of the housing.

2. The device for adjusting storage space of a magazine as claimed in claim 1, wherein a plurality of positioning holes are formed on another inner side of the housing of the magazine, the elastic members are fixed at the edge of the positioning holes by screws and nuts.

3. The device for adjusting storage space of a magazine as claimed in claim 1, wherein the lower fastener serves to fix the push member assembly.

4. The device for adjusting storage space of a magazine as claimed in claim 1, wherein the push block is provided with two restoring springs.

5. The device for adjusting storage space of a magazine as claimed in claim 1, wherein the guide plate is fixed at a front end of the push member assembly by screw and nut.
